(19) United States
(12) Patent Application Publication
(10) Pub. No.: US 2008/0145718 A1
(43) Pub. Date: Jun. 19, 2008

(54) Fuel Cell System and Method for Operating a Fuel Cell System

(76) Inventors: Willi Bette, Erlangen (DE); Detlev Coerlin, Erlangen (DE); Walter Stuhler, Hirschaid (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/631,053

(22) PCT Filed: Jun. 29, 2005
(86) PCT No.: PCT/EP2005/053051

§ 371 Date: Dec. 28, 2006

(30) Foreign Application Priority Data
Jul. 1, 2004 (EP) 04015501.2

(51) Int. Cl. H01M 8/04

(52) U.S. Cl. 429/13; 429/23

(57) ABSTRACT

The invention relates to a fuel cell system comprising a fuel cell stack whereon the reaction gas can be guided to the gas inlet slide and which comprises at least one flush valve, which is arranged on the gas outlet side, on a flush cell. A control device, which controls the actuation of the flush valve according to the voltage of the flush cell, is provided. The voltage tap is carried out in the region of the gas outlet towards the flush valve, in particular on a bipolar plate. Significantly sensitive and precise control is obtained by means of the lower voltage tap compared to a higher voltage tap and voltage dips are actively prevented in the flush cell, which enables the total risk of corrosion the maintained at a minimum for the bipolar metal plate.

### CROSS REFERENCE TO RELATED APPLICATIONS

This application is the US National Stage of International Application No. PCT/EP2005/053051, filed Jun. 29, 2005 and claims the benefit thereof. The International Application claims the benefits of European Patent application No. 04015501.2 filed Jul. 1, 2004. All of the applications are incorporated by reference herein in their entirety.

### FIELD OF INVENTION

The invention relates to a fuel cell system and a method for operating a fuel cell system.

### BACKGROUND OF THE INVENTION

When a fuel cell system is operated, for producing electric current a combustion gas, for example hydrogen, is customarily ducted on the anode side to a fuel cell block formed from stacked fuel cells, and air or oxygen is customarily ducted thereto as a further reaction gas on the cathode side. There are now many different types of fuel cell systems that differ with respect to their physical structure and, in particular, the electrolytes employed, as well as in terms of the required operating temperature. In what is termed a PEM (proton exchange membrane) fuel cell, a polymer membrane that is permeable to hydrogen protons is arranged between a gas permeable anode and a gas-permeable cathode. Since a single fuel cell supplies a voltage of only around 0.7 to 0.9 V, a plurality of fuel cells are electrically connected in series to form a stack. The individual fuel cells are therein customarily mutually separated by a bipolar plate. Said bipolar plate therein as a rule has a kind of fluted structure and abuts the anode or, as the case may be, cathode. By means of the fluted structure a gas space through which the reaction gases flow is formed between the bipolar plate and the anode or, as the case may be, cathode.

When a PEM fuel cell is operated, hydrogen protons migrate through the electrolyte to the oxygen side and react with the oxygen, with water being the product of this reaction. Water is additionally introduced into the gas spaces as a result of the customary humidifying of the reaction gases before they enter the fuel cell. Depending on the purity of the reaction gases used, inert gases also arise alongside the water. In the case of a fuel cell system having a plurality of fuel cell stacks arranged one after the other in series in a cascaded manner, the water and inert gases will accumulate in the last stack or fuel cell, where inert gas will consequently be added to the reaction gases. This “reactant diluting” causes a voltage drop at the last fuel cell or, as the case may be, the last fuel cell stack. Said fuel cell stack is therefore purged at specific intervals, which is to say a purge line connected at the gas outlet side to the stack is opened via a purge valve so that the accumulated water and inert gases will be discharged. The last fuel cell or last fuel cell stack is therefore referred to also as a purge cell or, as the case may be, purge cell stack. The voltage drop is customarily employed as the control signal for opening the purge valve. The concentration of inert gases is reduced by said purging so that the voltage level is raised again.

These conditions in the purge cell give rise to a risk of corrosion for the bipolar plates, in particular if the voltage drops to a region of a corrosion potential of the material used for the bipolar plates.

### SUMMARY OF INVENTION

The object of the invention is to enable reliable operation of a fuel cell system with minimal risk of corrosion.

Said object is achieved according to the invention by means of a fuel cell system having a fuel cell stack, consisting of a plurality of fuel cells, to which reaction gases can be ducted on the gas inlet side and which on the gas outlet side has at least one purge valve on a purge cell. The system further contains a control device, in particular a regulating device, that controls actuating of the purge valve as a function of the purge cell's voltage. Voltage tapping for measuring the voltage in the purge cell therein takes place in the vicinity of a gas outlet toward the purge valve. What is understood therein by “in the vicinity of a gas outlet” is the voltage tap's being sited approximately at the same level as the gas outlet. Voltage tapping therein takes place expediently in the—viewed in the direction of flow of the reaction gases—lower or nethermost region of the purge cell.

This embodiment is based on the consideration that the accumulated inert gases are not distributed evenly in the purge cell but rather collect in the lower region thereof in the direction of flow. During operation a concentration gradient of the reaction gases therefore becomes established in the direction of gas flow from a top gas inlet to the bottom gas outlet. Owing to that, the voltage produced in the purge cell is in part significantly higher, depending on the concentration of inert gas, in the vicinity of the top gas inlet than the voltage in the lower region in the vicinity of the gas outlet. With controlling by means of a top voltage tap in the vicinity of the gas inlet there would hence be a risk that only low voltages will be maintained in lower partial regions of the purge cell so that there will be a high risk of corrosion there. By means of the voltage tap in the lower region near the gas outlet, very precise and very sensitive controlling or regulating is achieved for actuating the purge valve, with significant improvements being gained in terms of control. What is particularly avoided thereby is that a predefined minimum voltage value constituting the lower control limit will be undershot in partial regions of the fuel cell. There will be more purging operations, which is to say the purge rate will be increased, compared to when a voltage tap is arranged in the top region. Voltage tapping preferably therein takes place in the vicinity of an edge side of a bipolar plate by which the fuel cell is delimited, with the gas outlet for the reaction gas being provided in the vicinity of said edge side.

To maximize the efficiency with which the reaction gases can be utilized, the fuel cell system has a plurality of fuel cell stacks arranged in a cascaded manner. What is understood thereby is a series of fuel cell stacks through which the reaction gases flow in succession, with the number of fuel cells in the individual stacks arranged one after the other successively reducing in number in the reaction gases' direction of flow. The reduction in the number of fuel cells is therein harmonized with the respective residual amount of gas exiting the preceding fuel cell stack. The last fuel cell stack is embodied as a purge cell stack having one or a plurality of purge cells followed by the purge valve.

The fuel cell system is preferably embodied having PEM fuel cells.

The object is furthermore inventively achieved by means of a method for operating a fuel cell system having a fuel cell stack to which reaction gases are ducted on the gas inlet side and which on the gas outlet side has a purge cell having a purge valve, with said purge cell's voltage being measured in the vicinity of a gas outlet toward the purge valve and actuating of the purge valve being controlled as a function of the purge cell's voltage.

The advantages and preferred embodiments cited with reference to the fuel cell system are also to be applied analogously to the method.

### BRIEF DESCRIPTION OF THE DRAWINGS

An exemplary embodiment of the invention is explained in more detail below with reference to the drawings. The figures listed below are each highly simplified schematics.

FIG. 1 shows a physical structure of a fuel cell system having fuel cell stacks arranged in a cascaded manner,

FIG. 2 shows a metallic bipolar plate having a top gas inlet and a bottom gas outlet,

FIG. 3A is a voltage curve measured in a top region of the bipolar plate, with purge cell controlling taking place as a function of a top voltage tap,

FIG. 3B is the voltage curve, measured in the lower region of the bipolar plate, for controlling according to FIG. 3A as a function of the top voltage tap,

FIG. 4A is a voltage curve measured in the lower region of the bipolar plate, with purge cell controlling taking place as a function of a bottom voltage tap in the vicinity of the gas outlet, and

FIG. 4B is the voltage curve, measured in the top region of the bipolar plate, for controlling according to FIG. 4A as a function of the bottom voltage tap.

### DETAILED DESCRIPTION OF INVENTION

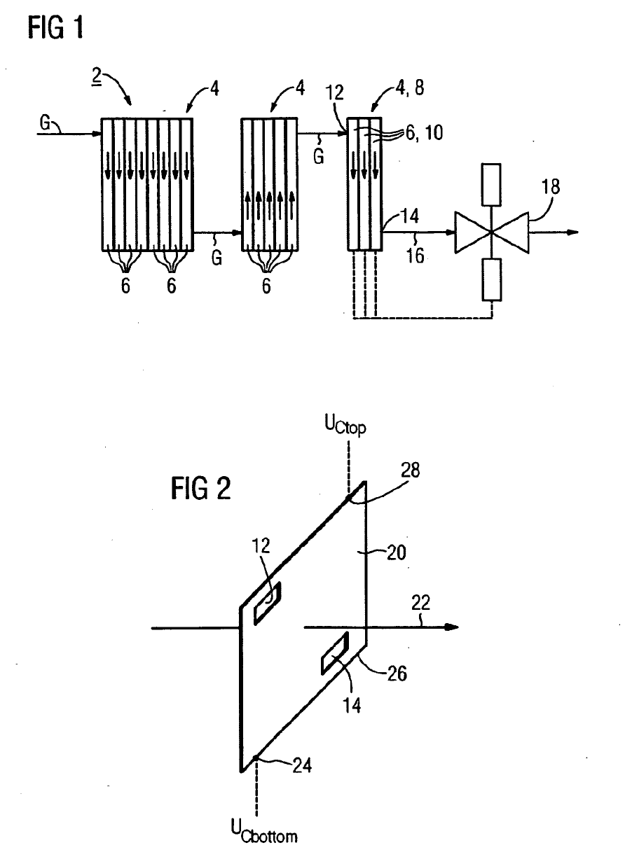

According to FIG. 1 a fuel cell system 2 contains a plurality of fuel cell stacks 4 that are mutually arranged in a cascaded manner and consist in turn of a plurality of fuel cells 6. The individual fuel cell stacks 4 are therein arranged mutually in series on the gas side. A reaction gas G is ducted in a top region to the first fuel cell stack on the gas side and flows in parallel through the individual fuel cells 6 in a downward direction indicated by the arrow. Having flowed downward, the reaction gas G exits the first fuel cell stack 4 and is ducted into the next fuel cell stack 4.

The last fuel cell stack is embodied as a purge cell stack 8 having a plurality of purge cells 10. The reaction gas G is ducted in the vicinity of a gas inlet 12 to the purge cell stack 8 and flows downward through the individual purge cells 10 toward a gas outlet 14. Said gas outlet 14 is followed by a purge line 16 that can be closed via a controllable purge valve 18.

The individual purge cells 10 are mutually separated by a bipolar plate 20, shown schematically in FIG. 2, which in each case has the top gas inlet 12 and bottom gas outlet 14. The terms “bottom” and “top” relate here to the direction of flow of the reaction gas G. The direction 22 of the electric current flowing during operation is oriented perpendicularly to the bipolar plate 20, as is indicated by the arrow.

The purge valve 18 is initially closed when the fuel cell system is operating so that the water G forming during the reaction as well as inert gases present in the reaction gases will accumulate in the purge cells 10. The purge cell voltage will drop owing to the accumulation of inert gases. Said voltage is measured and used for controlling a purging operation, which is to say for controlling the purge valve 18. If the voltage falls below a predefined control value, the purge valve 18 will open and the water produced by the reaction as well as the residual gas in the purge cells 10, in particular the inert gases, will be discharged. Both the oxygen side or cathode side and the hydrogen side or anode side of the purge cells 10 are therein expediently preferably each purged, in particular simultaneously, via a separate purge valve 18.

The purge cells will, owing to the accumulation of inert gases, not be supplied adequately with the reaction gases when current is flowing simultaneously. The boundary conditions are thus present for performing an electrolysis of water and the result on the anode side is the partial reaction 4OH⁻>O₂+2H₂O+2e⁻. Oxygen is thus produced which can cause corrosion in the case of the customarily metallic bipolar plate 20. That problem will exist particularly when the voltage in the purge cells 10 drops to the region of the corrosion potential of the material used for the bipolar plates 20.

To prevent corrosion of said type and in order not to allow the voltage of the purge cells 10 to fall below a specific threshold in, where possible, any partial region of the purge cells 10, it is provided for a voltage tap 24 for controlling purging in the lower region of the bipolar plate 20 to be sited approximately at the same level as the gas outlet 14, in particular on the bottom edge side 26 of the bipolar plate 20. The bottom cell voltage U_{Cbottom} is measured at said bottom voltage tap 24. A top voltage tap 28 at which a top cell voltage U_{Ctop} is tapped is furthermore indicated in FIG. 2 by a dot-and-dash line.

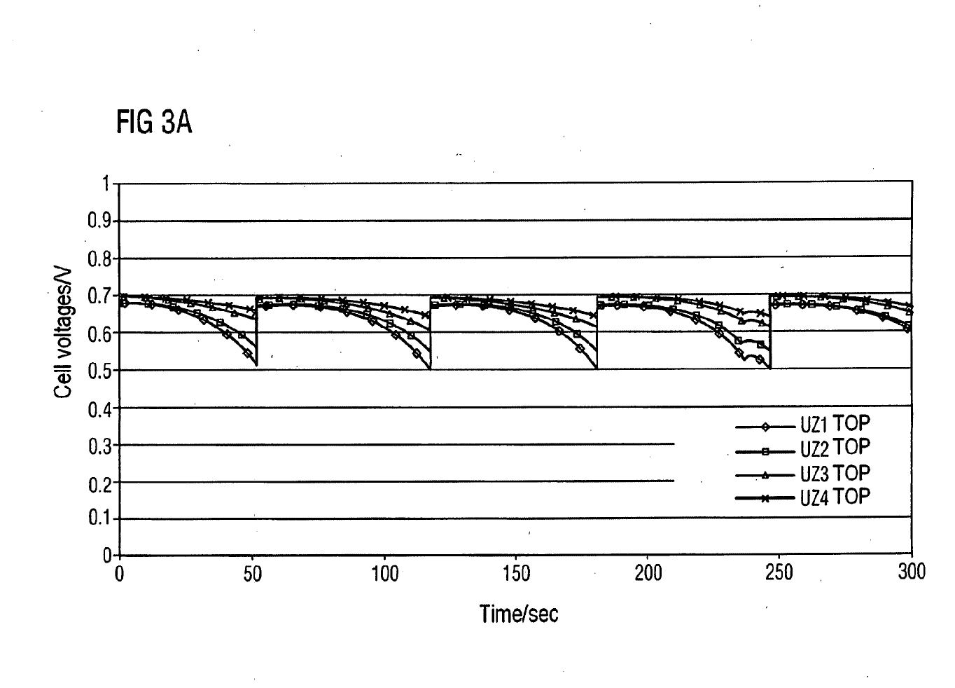

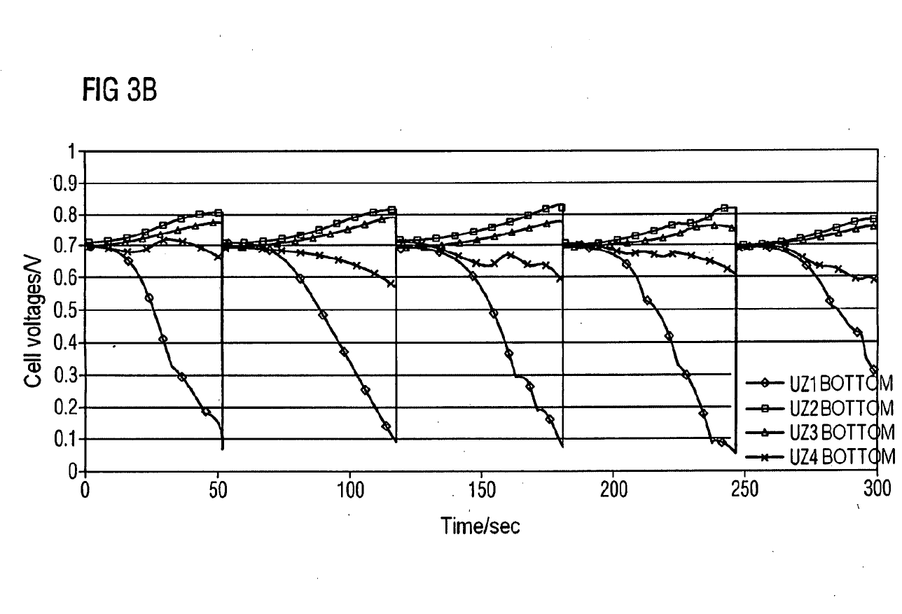

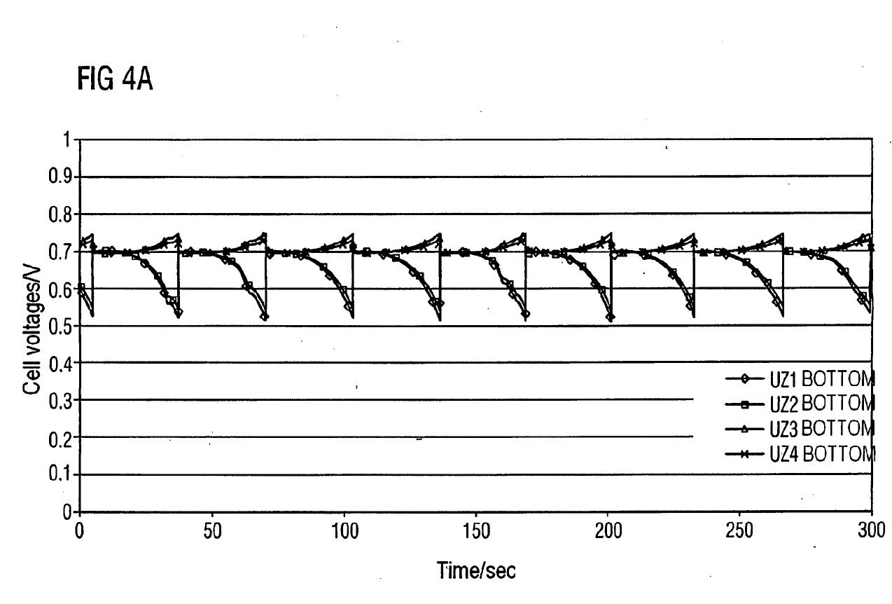

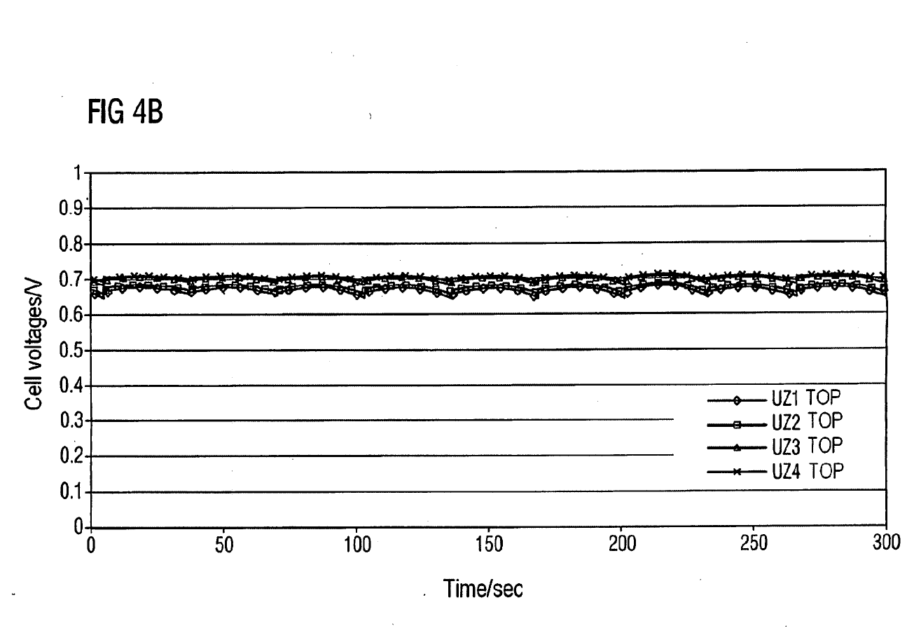

Significantly more sensitive and improved voltage controlling is achieved by means of the bottom voltage tap 24 compared to the top voltage tap 28. What is particularly prevented thereby is that the voltage will fall below a desired threshold of, for example, around 0.5 V in the lower region of the bipolar plate 20. Said threshold is here preferably selected as being above the corrosion potential of the material of the bipolar plate 20. That is because measurements have shown that a significant voltage gradient becomes established between U_{Ctop} and U_{Cbottom} owing to the inert gases' accumulating primarily in the vicinity of the gas outlet 14. The differences between purge cell controlling performed as a function of U_{Ctop} and as a function of U_{Cbottom} are apparent from the voltage curves shown in FIGS. 3A, 3B, 4A, 4B.

The individual voltage curves shown by way of example are therein based on a test system having a purge cell stack 8 that has four purge cells 10 through each of which a current of around 560 A flows. The curves of the four purge cells 10 are shown in each of the diagrams.

In FIGS. 3A and 3B, purging has been controlled as a function of the voltage U_{Ctop}; in the curves shown in FIGS. 4A and 4B, purging has been controlled as a function of the voltage U_{Cbottom}. The voltage U_{Ctop} has therein been applied to FIG. 3A and the voltage U_{Cbottom} to FIG. 3B. The voltage U_{Cbottom} has been applied to FIG. 4A and the voltage U_{Ctop} to FIG. 4B.

As will be apparent from comparing FIGS. 3A and 3B, when controlling takes place as a function of U_{Ctop} there are in part dramatic voltage dips in the lower cell region, as is shown by the voltage curve U_{Cbottom}. Despite controlling to a bottom cell voltage of around 0.5 for U_{Ctop}, there is in part a voltage drop to below 0.1 V in the case of the bottom voltage tap 24 for U_{Cbottom}. As is further apparent from the diagrams, owing to said controlling as a function of U_{Ctop}, purging takes place every 50-60 seconds or so with the selected boundary conditions. The voltage values in the individual purge cells 10 regain the standard voltage of around 0.7 V after a purging operation.

In contrast to controlling based on U_{Ctop}, controlling based on U_{Cbottom} is significantly more sensitive and precise, as is apparent from FIGS. 4A and 4B. As is immediately apparent from FIG. 4A, there is also no longer a voltage drop to below the set control value of 0.5 V in the lower region of the bipolar plate 20. The voltage in the top region in the vicinity of the top voltage tap 28 at the same time remains at an almost consistently high level of between 0.65 and 0.7 V (FIG. 4B).

As is particularly apparent from comparing FIGS. 3A and 4A, in the case of more sensitive controlling as a function of U_{Cbottom} a purging rate is provided that is almost twice that provided in the case of controlling based on U_{Ctop}. That is because, according to FIG. 4A, purging takes place approximately every 30-35 seconds at the selected boundary conditions.

Thus, thanks to more frequently performed purging operations, less water forming as a reaction product and a smaller amount of inert gases will accumulate in the purge cells 10. The purge cell voltage remains significantly higher. The risk of corrosion for the bipolar plates 20 is reduced overall thereby. To minimize the loss of residual reaction gases due to more frequent purging, the purge time or the cross-section of flow of the purge valve 18 is selected as being appropriately small.

1.-6. (canceled)

7. A fuel cell system, comprising:
a fuel cell stack comprised of a plurality of fuel cells where the stack has an inlet side and an outlet side where reaction gases are directed to the inlet side and a purge cell is arranged opposite the inlet side at the outlet side of the stack;
a gas outlet arranged on the purge cell of the stack;
a purge valve arranged on the gas outlet;
a control device that controls actuation of the purge valve as a function of a voltage of the purge cell; and
a voltage tap arranged in a region of an edge side.

8. The fuel cell system as claimed in claim 7, further comprising:
a bipolar plate arranged between the purge cell and an adjacent fuel cell where the gas outlet is arranged in a region of a bottom edge side of the bipolar plate.

9. The fuel cell system as claimed in claim 8, wherein a plurality of fuel cell stacks are arranged in a cascade manner.

10. The fuel cell system as claimed in claim 9, wherein the fuel cells are a PEM type.

11. A method for operating a fuel cell system, comprising:
ducting reaction gasses to a gas inlet side of a fuel cell stack;
arranging a purge cell at an outlet side of the fuel cell stack;
arranging a purge valve at a gas outlet of the purge cell;
measuring an associated voltage of the purge cell in proximity of the gas outlet; and
controlling an actuation of the purge valve as a function of the measured voltage.

12. The method as claimed in claim 11, wherein a plurality of fuel cell stacks are cascaded through which the reaction gases flow in series.

13. The method as claimed in claim 12, wherein a bipolar plate is arranged between the purge cell and an adjacent fuel cell of the stack and the gas outlet is arranged in a region of a bottom edge side of the bipolar plate.

14. The method as claimed in claim 13, wherein the fuel cells are a PEM type.
